(19) United States
(12) Patent Application Publication
(10) Pub. No.: US 2021/0360346 A1
(43) Pub. Date: Nov. 18, 2021

(54) CONTROL CIRCUIT, CONTROL DEVICE, AND SYSTEM

(71) Applicants: Shindengen Electric Manufacturing Co., Ltd., Tokyo (JP); Sumitomo Riko Company Limited, Aichi (JP)

(72) Inventors: Masaaki HAYASHI, Saitama (JP); Kazuhiko SAITO, Saitama (JP); Hiroki HARA, Saitama (JP); Katsuhiko NAKANO, Aichi (JP); Takanori MURASE, Aichi (JP)

(73) Assignees: Shindengen Electric Manufacturing Co., Ltd., Tokyo (JP); Sumitomo Riko Company Limited, Aichi (JP)

(21) Appl. No.: 17/283,964

(22) PCT Filed: Oct. 15, 2019
(86) PCT No.: PCT/JP2019/040452

§ 371 Date: Apr. 9, 2021

(30) Foreign Application Priority Data
Oct. 15, 2018 (JP) 2018-193978

(51) Int. Cl. H04R 3/00; H04R 19/02; H04R 19/04; H04R 29/00

(52) U.S. Cl. CPC H04R 3/00; H04R 19/02; H04R 2400/01; H04R 29/00; H04R 19/04

(57) ABSTRACT

A control circuit includes: a voltage output circuit control unit that controls a voltage output circuit so as to apply a voltage, which corresponds to an output control signal and is to cause an electrostatic transducer to generate vibration, sound, or pressure, between both ends of the electrostatic transducer in a case where a detection control signal is at a first level, and that stops the voltage output circuit in a case where the detection control signal is at a second level; a pulse signal output unit that outputs a pulse signal, which is to cause the electrostatic transducer to detect vibration, sound, or pressure, to a terminal on a high potential side of the electrostatic transducer via a diode; and a voltage clamp unit that outputs a clamp voltage acquired by clamping of a voltage between the terminals of the electrostatic transducer to a predetermined voltage or lower.

### FIELD

The present invention relates to a control circuit, a control device, and a system.

### BACKGROUND

An electrostatic transducer capable of generating vibration, sound, or pressure and detecting vibration, sound, or pressure is described in Patent Literature 1.

In a case of causing this electrostatic transducer to generate vibration, sound, or pressure and to detect vibration, sound, or pressure, it has been necessary to control a first electrostatic transducer for generating vibration, sound, or pressure by a first control circuit, and to control a second electrostatic transducer for detecting vibration, sound, or pressure by a second control circuit.

However, it is desired that one control circuit controls one electrostatic transducer to generate vibration, sound, or pressure and to detect vibration, sound, or pressure.

### CITATION LIST

### Patent Literature

Patent Literature 1: JP 2017-183814 A

### SUMMARY

### Technical Problem

The present invention is to provide a control circuit, a control device, and a system that cause one electrostatic transducer to generate vibration, sound, or pressure and to detect vibration, sound, or pressure.

### Solution to Problem

A control circuit according to an aspect of the present invention that controls an electrostatic transducer capable of generating vibration, sound, or pressure and detecting vibration, sound, or pressure, the control circuit comprising: a voltage output circuit control unit that controls a voltage output circuit in such a manner as to apply a voltage, which corresponds to an output control signal and is to cause the electrostatic transducer to generate vibration, sound, or pressure, between both ends of the electrostatic transducer in a case where a detection control signal is at a first level, and that stops the voltage output circuit in a case where the detection control signal is at a second level; a pulse signal output unit that outputs a pulse signal, which is to cause the electrostatic transducer to detect vibration, sound, or pressure, to a terminal on a high potential side of the electrostatic transducer via a diode; and a voltage clamp unit that outputs a clamp voltage acquired by clamping of a voltage between the terminals of the electrostatic transducer to a predetermined voltage or lower.

In the control circuit, the pulse signal output unit generates the pulse signal when the detection control signal changes from the first level to the second level.

The control circuit, further comprising a first signal output unit that outputs the detection control signal at the second level in a case where the output control signal indicates that a voltage equal to or lower than the predetermined voltage is output between the both ends of the electrostatic transducer and a case where the clamp voltage is equal to or lower than the predetermined voltage, and outputs the detection control signal at the first level in a case where the output control signal indicates that a voltage higher than the predetermined voltage is output between the both ends of the electrostatic transducer or a case where the clamp voltage is higher than the predetermined voltage.

In the control circuit, the first signal output unit includes a first comparator that compares the clamp voltage with a first threshold voltage, a second comparator that compares the output control signal with a second threshold voltage, and a flip-flop that is set by an output signal of the first comparator, is reset by an output signal of the second comparator, and outputs the detection control signal.

In the control circuit, the first signal output unit further includes a mask circuit that masks the output signal of the first comparator in a predetermined period after the detection control signal changes.

In the control circuit, the pulse signal output unit generates the pulse signal in a case where the clamp voltage is equal to or lower than a third threshold voltage.

A control circuit according to an aspect of the present invention that controls an electrostatic transducer capable of generating vibration, sound, or pressure and detecting vibration, sound, or pressure, the control circuit comprising: a voltage output circuit control unit that controls a voltage output circuit in such a manner as to apply a voltage, which corresponds to an input signal, between both ends of the electrostatic transducer in a case where a detection control signal is at a first level, and that stops the voltage output circuit in a case where the detection control signal is at a second level; a voltage clamp unit that outputs a clamp voltage acquired by clamping of a voltage between the terminals of the electrostatic transducer to a predetermined voltage or lower; a first signal output unit that outputs a signal at the second level in a case where an output control signal indicates that a voltage equal to or lower than the predetermined voltage is output between the both ends of the electrostatic transducer and a case where the clamp voltage is equal to or lower than the predetermined voltage, and outputs a signal at the first level in a case where the output control signal indicates that a voltage higher than the predetermined voltage is output between the both ends of the electrostatic transducer or a case where the clamp voltage is higher than the predetermined voltage; a second signal output unit that outputs the signal at the second level when the clamp voltage is increased above the predetermined voltage, and outputs the signal at the first level when the clamp voltage is decreased below a third threshold voltage; a third signal output unit that outputs the detection control signal at the second level in a case where a signal output by the first signal output unit is at the second level and a signal output by the second signal output unit is at the second level, and outputs the detection control signal at the first level in a case where the signal output by the first signal output unit is at the first level or the signal output by the second signal output unit is at the first level; and a fourth signal output unit that outputs the output control signal as the input signal to the voltage output circuit control unit in a case where the signal output by the first signal output unit is at the first level, and outputs a second threshold voltage as the input signal to the voltage output circuit control unit in a case where the signal output by the first signal output unit is at the second level.

In the control circuit, the voltage clamp unit includes a transistor a drain of which is connected to the terminal on the high potential side of the electrostatic transducer, to a gate of which a bias voltage is supplied, and from a source of which the clamp voltage is output, and a bias cut-off unit that cuts off supply of the bias voltage to the gate in a case where the detection control signal is at the first level.

In the control circuit, the electrostatic transducer is an electrostatic actuator or an electrostatic pressure detecting element.

In the control circuit, the control circuit is a semiconductor integrated circuit.

A control device according to an aspect of the present invention comprising: the above control circuit; and the voltage output circuit.

A system according to an aspect of the present invention comprising: the above control device; and a voltage change detection unit that detects vibration, sound, or pressure applied to the electrostatic transducer on the basis of a change in the clamp voltage.

### Advantageous Effects of Invention

A control circuit, control device, and system of one aspect of the present invention have an effect of causing one electrostatic transducer to generate vibration, sound, or pressure and to detect vibration, sound, or pressure.

### BRIEF DESCRIPTION OF DRAWINGS

FIG. 1 is a view illustrating a configuration of a system using a control device of a first embodiment.

FIG. 2 is a view for describing a detection principle of an electrostatic transducer.

FIG. 3 is a view for describing the detection principle of the electrostatic transducer.

FIG. 4 is a view illustrating a configuration of a system using a control device of a second embodiment.

FIG. 5 is a view illustrating a configuration of a system using a control device of a third embodiment.

FIG. 6 is a view illustrating a configuration of a system using a control device of a fourth embodiment.

FIG. 7 is a view illustrating a configuration of a system using a control device of a fifth embodiment.

FIG. 8 is a view illustrating a voltage waveform of an electrostatic transducer of the fifth embodiment.

FIG. 9 is a view illustrating a voltage waveform of the electrostatic transducer of the fifth embodiment.

FIG. 10 is a view illustrating a voltage waveform of the electrostatic transducer of the fifth embodiment.

FIG. 11 is a view illustrating a configuration of a system using a control device of a sixth embodiment.

### DESCRIPTION OF EMBODIMENTS

In the following, embodiments of a control circuit and control device of the present invention will be described in detail on the basis of the drawings. Note that the present invention is not limited to these embodiments.

### First Embodiment

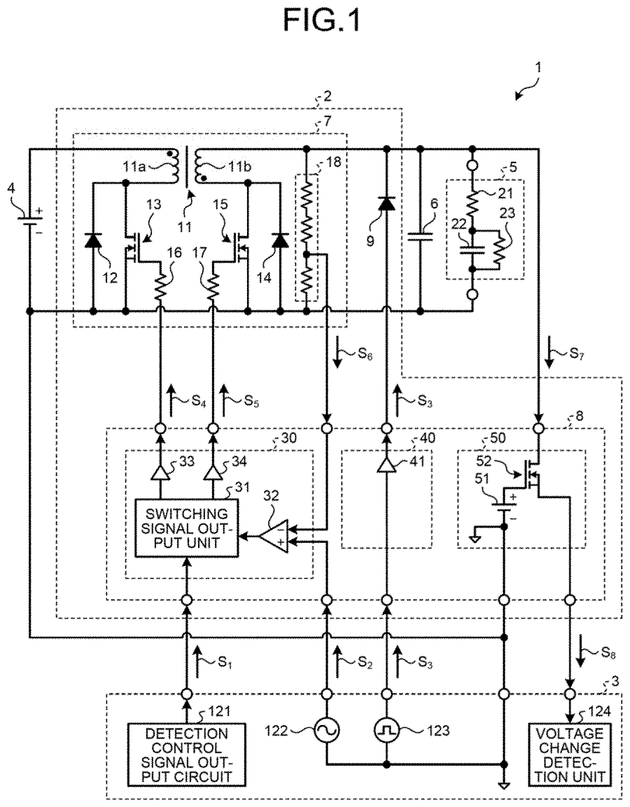

FIG. 1 is a view illustrating a configuration of a system using a control device of the first embodiment. A system 1 includes a control device 2, a microcomputer 3, a DC power supply 4, an electrostatic transducer 5, and a capacitor 6.

The electrostatic transducer 5 is exemplified by an electrostatic transducer described in Patent Literature 1, but the present disclosure is not limited thereto. The electrostatic transducer 5 may be referred to as an electrostatic actuator or an electrostatic pressure detecting element.

The electrostatic transducer 5 is represented by an equivalent circuit of a resistor 21 and a capacitor 22 connected in series, and a resistor 23 connected in parallel to the capacitor 22.

When a high voltage (such as 410 V) is applied, the electrostatic transducer 5 can generate vibration, sound, or pressure by a change in a distance between both electrodes of the capacitor 22.

Also, when vibration, sound, or pressure is applied, a time constant changes by a change in a distance between both electrodes of the capacitor 22, and the electrostatic transducer 5 can detect the vibration, sound, or pressure.

The capacitor 6 is electrically connected in parallel to the electrostatic transducer 5. The capacitor 6 smoothes a voltage applied to the electrostatic transducer 5.

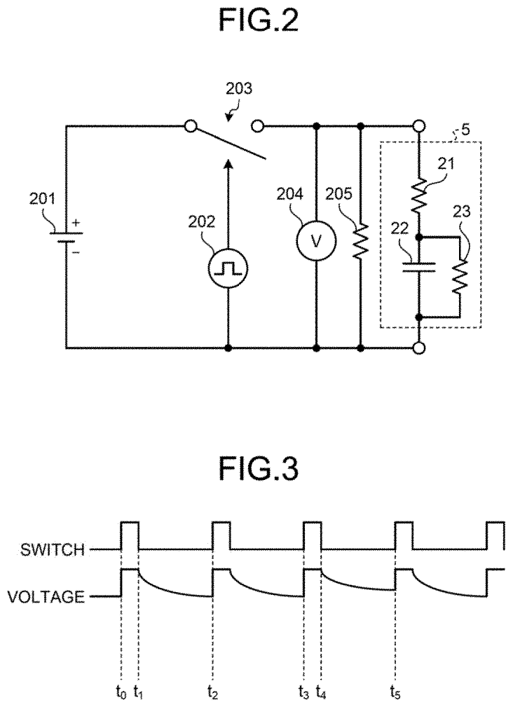

FIG. 2 and FIG. 3 are views for describing a detection principle of an electrostatic transducer.

A switch 203 is turned on and off according to a pulse signal generated by a pulse generation circuit 202.

The switch 203 is brought into an on-state in a case where the pulse signal is at a high level. When the switch 203 is brought into the on-state, a voltage of a DC power supply 201 is applied to the electrostatic transducer 5 and an electric charge is charged into the capacitor 22. The voltage of the DC power supply 201 is exemplified by 5 V that is a predetermined voltage, but the present disclosure is not limited thereto.

The switch 203 is brought into an off-state in a case where the pulse signal is at a low level. When the switch 203 is brought into the off-state, the electric charge charged in the capacitor 22 is discharged through a resistor 205. A voltage detection circuit 204 detects a voltage of the electrostatic transducer 5.

With reference to FIG. 3, the voltage of the electrostatic transducer 5 becomes the same as the voltage of the DC power supply 201 when the switch 203 is brought into the on-state in a period from timing t₀ to timing t₁.

When the switch 203 is brought into the off-state in a period from the timing t₁ to timing t₂, the electric charge charged in the capacitor 22 is discharged. Thus, the voltage of the electrostatic transducer 5 is decreased according to time constants of the resistor 21, the capacitor 22, the resistor 23, and the resistor 205.

The switch 203 is in the on-state in a period from timing t₃ to timing t₄. Here, when vibration, sound, or pressure is applied to the electrostatic transducer 5, the distance between both electrodes of the capacitor 22 becomes short and capacitance of the capacitor 22 becomes large. That is, the time constants of the resistor 21, the capacitor 22, the resistor 23, and the resistor 205 become large.

When the switch 203 is brought into the off-state in a period from the timing t₄ to timing t₅, the electric charge charged in the capacitor 22 is discharged. At this time, the time constants of the resistor 21, the capacitor 22, the resistor 23, and the resistor 205 are increased. Thus, the voltage of the electrostatic transducer 5 is decreased slowly compared to the period from the timing t₁ to the timing t₂. As a result, the electrostatic transducer 5 can detect vibration, sound, or pressure.

With reference to FIG. 1 again, the control device 2 includes a voltage output circuit 7 and a control circuit 8.

The voltage output circuit 7 is assumed to be a flyback-type converter, but the present disclosure is not limited thereto. The voltage output circuit 7 may be a forward-type converter or an inverter.

The control circuit 8 controls the voltage output circuit 7 under the control of the microcomputer 3. Under the control of the control circuit 8, the voltage output circuit 7 converts electric power of the DC power supply 4 and applies the converted electric power to the electrostatic transducer 5.

The voltage of the DC power supply 4 is exemplified by 12 V, but the present disclosure is not limited thereto. The voltage applied to the electrostatic transducer 5 by the voltage output circuit 7 is assumed to be a voltage that changes in a sinusoidal manner between 0 V and 410 V, but the present disclosure is not limited thereto.

The control circuit 8 operates the voltage output circuit 7 in a case of causing the electrostatic transducer 5 to generate vibration, sound, or pressure.

The control circuit 8 stops the voltage output circuit 7 in a case of causing the electrostatic transducer 5 to detect vibration, sound, or pressure.

The control circuit 8 is assumed to be a driver integrated circuit (IC), but the present disclosure is not limited thereto.

The voltage output circuit 7 includes a transformer 11, diodes 12 and 14, N-channel transistors 13 and 15, resistors 16 and 17, and a voltage divider circuit 18.

The voltage divider circuit 18 outputs, to the control circuit 8, divided voltage S₆ acquired by division of voltage S₇ of the electrostatic transducer 5. The voltage divider circuit 18 is exemplified by division of the voltage of the electrostatic transducer 5 into 1/410, but the present disclosure is not limited thereto.

In the first embodiment, since the voltage output circuit 7 is a flyback-type converter, a primary winding wire 11a and a secondary winding wire 11b of the transformer 11 are wound in opposite polarities.

The voltage output circuit 7 is a regeneration type, and a primary-side circuit and a secondary-side circuit are symmetrical. Although the voltage output circuit 7 is a regeneration type, the present disclosure is not limited thereto.

Since the voltage output circuit 7 is a regeneration type, electric power on a side of the electrostatic transducer 5 can be regenerated on a side of the DC power supply 4. Thus, a power loss can be controlled.

One end of the primary winding wire 11a of the transformer 11 is electrically connected to a terminal on a high potential side of the DC power supply 4. An anode of the diode 12 is electrically connected to a terminal on a low potential side of the DC power supply 4. The terminal on the low potential side of the DC power supply 4 is electrically connected to a reference potential. The reference potential is exemplified by a ground potential, but the present disclosure is not limited thereto.

A cathode of the diode 12 is electrically connected to the other end of the primary winding wire 11a of the transformer 11. A drain-source path of the transistor 13 is electrically connected in parallel to the diode 12. A first switching signal S₄ is input from the control circuit 8 into a gate of the transistor 13 via the resistor 16.

One end of the secondary winding wire 11b of the transformer 11 is electrically connected to one end of the electrostatic transducer 5. An anode of the diode 14 is electrically connected to the other end of the electrostatic transducer 5. The other end of the electrostatic transducer 5 is electrically connected to the reference potential.

A cathode of the diode 14 is electrically connected to the other end of the secondary winding wire 11b of the transformer 11. A drain-source path of the transistor 15 is electrically connected in parallel to the diode 14. A second switching signal S₅ is input from the control circuit 8 into a gate of the transistor 15 via the resistor 17.

In a case where the voltage of the electrostatic transducer 5 is increased (for example, in a case of an increase in a sinusoidal manner from 0 V to 410 V), the control circuit 8 outputs the first switching signal S₄ of pulse width modulation (PWM) to the gate of the transistor 13 and causes the transistor 13 to perform a switching operation.

In a period in which the transistor 13 is in the on-state, energy is stored on a side of the primary winding wire 11a of the transformer 11. Energy is released from the secondary winding wire 11b of the transformer 11 in a period in which the transistor 13 is in the off-state. The energy released from the secondary winding wire 11b is rectified by the diode 14 and input into the electrostatic transducer 5.

In a case where the voltage of the electrostatic transducer 5 is decreased (for example, in a case of a decrease in a sinusoidal manner from 410 V to 0 V), the control circuit 8 outputs the second switching signal S₅ of PWM to the gate of the transistor 15 and causes the transistor 15 to perform a switching operation.

In a period in which the transistor 15 is in the on-state, energy is stored on a side of the secondary winding wire 11b of the transformer 11. Energy is released from the primary winding wire 11a of the transformer 11 in a period in which the transistor 15 is in the off-state. The energy emitted from the primary winding wire 11a is rectified by the diode 12 and input into the DC power supply 4.

The control circuit 8 includes a voltage output circuit control unit 30, a pulse signal output unit 40, and a voltage clamp unit 50.

The voltage output circuit control unit 30 includes a switching signal output unit 31, an error amplifier 32, and buffers 33 and 34.

An output control signal S₂ is input into a non-inverting input terminal of the error amplifier 32 from an output control signal output circuit 122 in the microcomputer 3. The output control signal S₂ is assumed to be a voltage that changes in a sinusoidal manner between 0 V and 1 V, but the present disclosure is not limited thereto.

The divided voltage S₆ is input from the voltage divider circuit 18 into an inverting input terminal of the error amplifier 32.

The error amplifier 32 outputs a signal corresponding to a difference between the output control signal S₂ and the divided voltage S₆ to the switching signal output unit 31. For example, the error amplifier 32 amplifies the difference between the output control signal S₂ and the divided voltage S₆, and performs an output thereof to the switching signal output unit 31.

A detection control signal S₁ is input into the switching signal output unit 31 from a detection control signal output circuit 121 in the microcomputer 3.

The detection control signal output circuit 121 outputs a detection control signal S₁ at a low level (first level) to the switching signal output unit 31 in a case of causing the electrostatic transducer 5 to output vibration, sound, or pressure.

The detection control signal output circuit 121 outputs a detection control signal S₁ at a high level (second level) to the switching signal output unit 31 in a case of causing the electrostatic transducer 5 to detect vibration, sound, or pressure.

In a case where the detection control signal S₁ is at the low level, the switching signal output unit 31 outputs the first switching signal S₄ or the second switching signal S₅ to the voltage output circuit 7 on the basis of the output signal of the error amplifier 32, and causes the voltage output circuit 7 to operate.

The switching signal output unit 31 outputs the first switching signal S₄ of PWM to the gate of the transistor 13 via the buffer 33 and the resistor 16. The switching signal output unit 31 outputs the second switching signal S₅ of PWM to the gate of the transistor 15 via the buffer 34 and the resistor 17.

In a case where the detection control signal S₁ is at the high level, the switching signal output unit 31 does not output the first switching signal S₄ and the second switching signal S₅ to the voltage output circuit 7, and stops the voltage output circuit 7.

The pulse signal output unit 40 includes a buffer 41. A pulse signal S₃ is input into the buffer 41 from a pulse signal generation circuit 123 in the microcomputer 3. It is assumed that a low level of the pulse signal S₃ is 0 V and a high level thereof is 5 V, but the present disclosure is not limited thereto. The buffer 41 outputs the pulse signal S₃ to one end of the electrostatic transducer 5 via a diode 9.

The diode 9 is a high-voltage type (for example, has pressure resistance of 410 V or higher). In a case where the voltage of the electrostatic transducer 5 is higher than an output voltage of the buffer 41, the diode 9 is brought into the off-state. Thus, it is possible to control application of a high voltage to the buffer 41, and the buffer 41 is protected.

The diode 9 may be provided in the control circuit 8 (driver IC).

The voltage clamp unit 50 includes a DC power supply 51 and an N-channel transistor 52. A terminal on a low potential side of the DC power supply 51 is electrically connected to a reference potential. A terminal on a high potential side of the DC power supply 51 is electrically connected to a gate of the transistor 52. A voltage of the DC power supply 51 is exemplified by 8 V, but the present disclosure is not limited thereto.

The transistor 52 is a high-voltage type (for example, has pressure resistance of 410 V or higher). A gate-source voltage threshold VTH of the transistor 52 is 3 V. Then, a bias voltage of 8 V is applied to the gate of the transistor 52. Thus, a source voltage of the transistor 52 is 5 V (=8 V−3 V) at the maximum.

The source voltage of the transistor 52 is equal to a drain voltage in a case where the drain voltage is equal to or lower than 5 V. The source voltage of the transistor 52 becomes 5 V in a case where the drain voltage is higher than 5 V. That is, the transistor 52 outputs, to a voltage change detection unit 124 in the microcomputer 3, a clamp voltage S₈ acquired by clamping of the voltage S₇ at one end of the electrostatic transducer 5 to equal to or lower than 5 V.

The voltage change detection unit 124 can detect vibration, sound, or pressure applied to the electrostatic transducer 5 on the basis of a change in the clamp voltage S₈ on the basis of the detection principle described with reference to FIG. 2 and FIG. 3. For example, by measuring time until the clamp voltage S₈ is decreased from 5 V to a predetermined voltage, the voltage change detection unit 124 can detect a time constant of the electrostatic transducer 5, that is, vibration, sound, or pressure applied to the electrostatic transducer 5.

The control device 2 can realize the following things with the above configuration.

For example, when it is assumed that the output control signal output circuit 122 outputs a pulse signal of 12 mV (=5 V/410) to the error amplifier 32 as the output control signal S₂, the voltage output circuit 7 can apply a pulse signal of 5 V to the electrostatic transducer 5. However, it is not easy for the output control signal output circuit 122 to output a pulse signal of 12 mV from a viewpoint of voltage accuracy.

Also, when it is assumed that a circuit capable of outputting a pulse signal of 5 V is directly connected to the electrostatic transducer 5, the circuit needs to have pressure resistance of 410 V, which is not easy.

However, in the control circuit 8, the pulse signal output unit 40 outputs a pulse signal S₃ of 5 V to the electrostatic transducer 5 via the high-voltage type diode 9 (for example, having pressure resistance of 410 V or higher). Thus, the pulse signal output unit 40 can output the pulse signal S₃ of 5 V to the electrostatic transducer 5 even when not being a high-voltage type.

As a result, one control circuit 8 can control one electrostatic transducer 5 to generate vibration, sound, or pressure and to detect vibration, sound, or pressure.

Also, as described in the detection principle described in FIG. 2 and FIG. 3, in order to detect vibration, sound, or pressure, the pulse signal output unit 40 needs to apply the pulse signal S₃ to the electrostatic transducer 5 and the voltage change detection unit 124 needs to detect a decrease in the voltage S₇ of the electrostatic transducer 5. However, at this time, when the voltage output circuit 7 is operating, the voltage output circuit 7 controls the voltage of the electrostatic transducer 5 into a voltage corresponding to the output control signal S₂. Thus, the voltage change detection unit 124 cannot detect a decrease in the voltage of the electrostatic transducer 5.

However, in the system 1, in a case of detecting vibration, sound, or pressure, the detection control signal output circuit 121 outputs a high-level detection control signal S₁ to the voltage output circuit control unit 30. Thus, the voltage output circuit control unit 30 does not output the first switching signal S₄ and the second switching signal S₅ to the voltage output circuit 7. Thus, the voltage output circuit 7 does not control the voltage of the electrostatic transducer 5 and has no effect.

As a result, the control circuit 8 can realize detection of the decrease in the voltage S₇ of the electrostatic transducer 5.

It is also conceivable that the voltage change detection unit 124 uses the divided voltage S₆, which is output from the voltage divider circuit 18, when detecting vibration, sound, or pressure. However, the voltage divider circuit 18 divides the voltage S₇ of the electrostatic transducer 5 into 1/410. Thus, the voltage change detection unit 124 needs to be able to detect a voltage of 12 mV (=5 V/410), which is not easy from a viewpoint of voltage accuracy. It is also conceivable to increase the voltage of the divided voltage S₆ by changing a voltage dividing ratio of the voltage divider circuit 18. However, in that case, when 410 V is applied to the electrostatic transducer 5, the voltage of the divided voltage S₆ becomes high, and the voltage change detection unit 124 needs a high-voltage circuit.

However, in the control circuit 8, the voltage clamp unit 50 outputs, to the voltage change detection unit 124, the clamp voltage S₈ acquired by clamping of the voltage S₇ at one end of the electrostatic transducer 5 to 5 V or lower.

Thus, when detecting vibration, sound, or pressure, the control circuit 8 can secure accuracy of the clamp voltage S₈ and secure accuracy of detecting a decrease in the voltage S₇ of the electrostatic transducer 5.

Note that in the first embodiment, the voltage output circuit control unit 30 does not output the first switching signal S₄ and the second switching signal S₅ to the voltage output circuit 7 in a case where the detection control signal S₁ is at the high level. Thus, since the detection control signal output circuit 121 can stop the operation of the voltage output circuit 7, the detection control signal output circuit 121 can be also used for switching to a standby state. The detection control signal output circuit 121 sets the detection control signal S₁ to the high level in a case of a transition into the standby state, and sets the detection control signal S₁ to the low level in a case of a transition into a normal operating state.

As a result, the control circuit 8 can control a power loss. Also, the control circuit 8 can eliminate a need for a terminal and a signal line with respect to the microcomputer 3 which terminal and signal line are for a transition between the standby state and the normal operating state.

### Second Embodiment

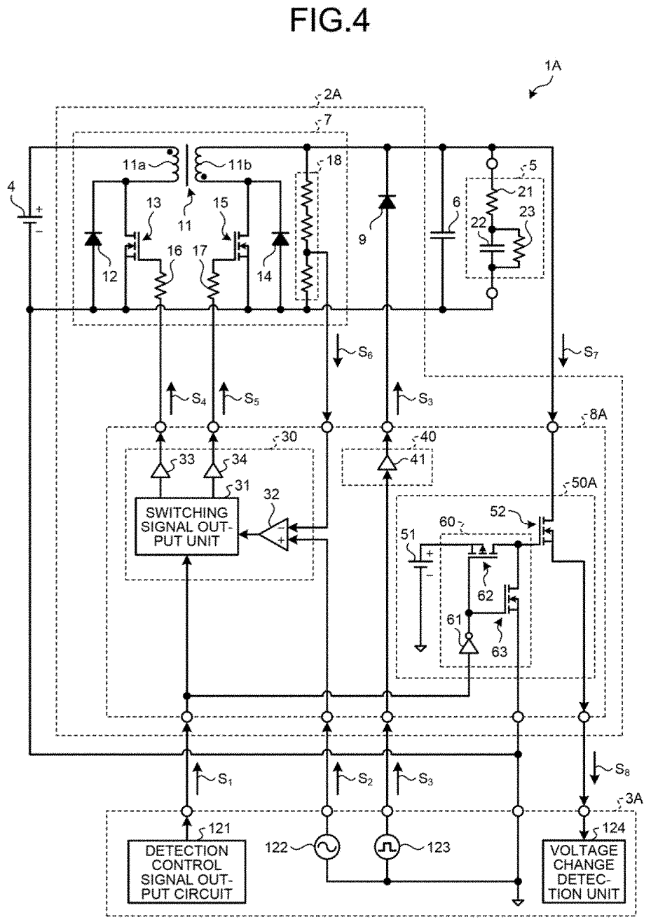

FIG. 4 is a view illustrating a configuration of a system using a control device of the second embodiment. Note that the same reference signs are assigned to components similar to those of the first embodiment, and a description thereof will be omitted.

A system 1A includes a control device 2A. The control device 2A includes a control circuit 8A. The control circuit 8A includes a voltage clamp unit 50A instead of the voltage clamp unit 50 (see FIG. 1).

The voltage clamp unit 50A further includes a bias cut-off unit 60 in addition to a DC power supply 51 and a transistor 52. The bias cut-off unit 60 cuts off supply of a bias voltage to a gate of the transistor 52 in a case where a detection control signal S₁ is at a low level.

The bias cut-off unit 60 includes an inverter (inverting circuit) 61, a P-channel transistor 62, and an N-channel transistor 63.

A source-drain path of the transistor 62 is connected between a terminal on a high potential side of the DC power supply 51 and the gate of the transistor 52.

A drain-source path of the transistor 63 is connected between the gate of the transistor 52 and a reference potential.

The inverter 61 inverts the detection control signal S₁ and performs an output thereof to gates of the transistors 62 and 63. The transistor 62 is brought into an off-state in a case where the detection control signal S₁ is at the low level, and is brought into an on-state in a case where the detection control signal S₁ is at a high level. The transistor 63 is brought into an on-state in a case where the detection control signal S₁ is at the low level, and is brought into an off-state in a case where the detection control signal S₁ is at the high level.

Thus, in a case where the detection control signal S₁ is at the high level (in a case where vibration, sound, or pressure is detected), the gate of the transistor 52 is electrically connected to the terminal on the high potential side of the DC power supply 51 via the source-drain path of the transistor 62. As a result, a bias voltage is supplied to the gate of the transistor 52.

On the one hand, in a case where the detection control signal S₁ is at the low level (in a case where vibration, sound, or pressure is generated), the gate of the transistor 52 is electrically connected to the reference potential via the drain-source path of transistor 63. As a result, no bias voltage is supplied to the gate of the transistor 52. Thus, the transistor 52 is brought into the off-state.

With the above configuration, the control circuit 8A can bring the transistor 52 into the off-state in a case where the detection control signal S₁ is at the low level (in a case where vibration, sound, or pressure is generated). Thus, the control circuit 8A can control a power loss in the transistor 52 in a case where the detection control signal S₁ is at the low level (in a case where vibration, sound, or pressure is generated).

### Third Embodiment

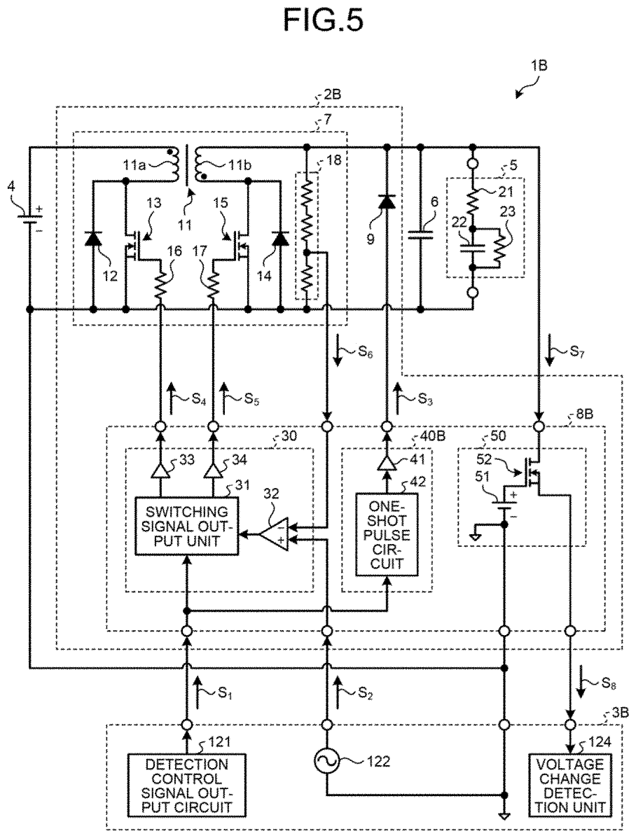

FIG. 5 is a view illustrating a configuration of a system using a control device of the third embodiment. Note that the same reference signs are assigned to components similar to those of the first or second embodiment, and a description thereof will be omitted.

A system 1B includes a control device 2B. The control device 2B includes a control circuit 8B. The control circuit 8B includes a pulse signal output unit 40B instead of the pulse signal output unit 40 (see FIG. 1).

The pulse signal output unit 40B further includes a one-shot pulse circuit 42 in addition to a buffer 41. The one-shot pulse circuit 42 outputs a pulse signal of a predetermined time width to the buffer 41 when a detection control signal S₁ changes from a low level (case where vibration, sound, or pressure is generated) to a high level (case where vibration, sound, or pressure is detected). The buffer 41 applies the pulse signal output from the one-shot pulse circuit 42 to an electrostatic transducer 5 via a diode 9.

Note that a microcomputer 3B does not include a pulse signal generation circuit 123 as compared with the microcomputer 3 (see FIG. 1). While a detection control signal output circuit 121 switches the detection control signal S₁ from a low bell to the high level and a voltage change detection unit 124 detects a decreased voltage of a clamp voltage S₈ at timing at which a pulse signal S₃ is to be output, repetition of an operation of keeping the detection control signal S₁ at the high level by the detection control signal output circuit 121, and a configuration of the control circuit 8B can substitute for the pulse signal generation circuit 123.

With the above configuration, the control circuit 8B can apply a pulse signal to the electrostatic transducer 5 when the detection control signal S₁ changes from the low level (case where vibration, sound, or pressure is generated) to the high level (case where vibration, sound, or pressure is detected). Thus, the control circuit 8B can enable the detection of vibration, sound, or pressure even when a pulse signal S₃ (see FIG. 1) is not input from the microcomputer 3B. Thus, with the control circuit 8B, it is possible to reduce a signal line with respect to the microcomputer 3B. Also, the control circuit 8B can eliminate a need for the microcomputer 3B to include the pulse signal generation circuit 123.

Note that the third embodiment may be combined with the second embodiment. That is, a control circuit 8B may include a voltage clamp unit 50A (see FIG. 4) instead of a voltage clamp unit 50.

### Fourth Embodiment

In the systems 1, 1A, and 1B of the first to third embodiments, it is possible to suitably detect vibration, sound, or pressure in a case where a period of generating vibration, sound, or pressure and a period of detecting vibration, sound, or pressure are separated.

However, in the systems 1, 1A, and 1B, there is a possibility that vibration, sound, or pressure cannot be detected suitably in a case where a period of generating vibration, sound, or pressure (hereinafter, referred to as generation period) and a period of detecting vibration, sound, or pressure (hereinafter, referred to as detection period) are mixed.

Specifically, in the generation period, a voltage output circuit 7 applies a sinusoidal voltage that changes from 0 V to 410 V to an electrostatic transducer 5. Here, it is conceivable that the systems 1, 1A, and 1B detect vibration, sound, or pressure in a period in which a voltage S₇ of the electrostatic transducer 5 is 5 V or lower (period of a valley bottom of the sinusoidal voltage S₇).

At this time, in a case where the systems 1, 1A, and 1B have no circuit delay, phase delay, or the like, each of the microcomputers 3, 3A, and 3B can suitably detect vibration, sound, or pressure by outputting a high-level detection control signal S₁ in a period in which the voltage S₇ of the electrostatic transducer 5 is 5 V or lower.

However, in a case where the systems 1, 1A, and 1B have a circuit delay, phase delay, or the like, each of the microcomputers 3, 3A, and 3B cannot output the high-level detection control signal S₁ in a period in which the voltage S₇ of the electrostatic transducer 5 is 5 V or lower, and cannot suitably detect vibration, sound, or pressure.

In the fourth embodiment, it is possible to suitably detect vibration, sound, or pressure regardless of a circuit delay, phase delay, or the like.

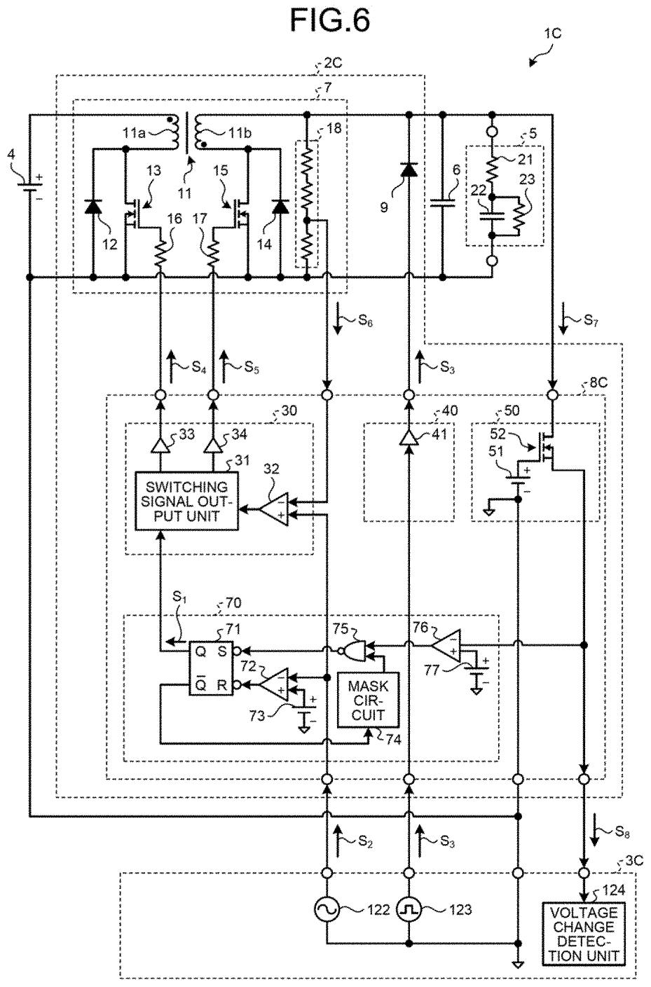

FIG. 6 is a view illustrating a configuration of a system using a control device of the fourth embodiment. Note that the same reference signs are assigned to components similar to those of the first to third embodiments, and a description thereof will be omitted.

A system 1C includes a control device 2C. The control device 2C includes a control circuit 8C. The control circuit 8C further includes a first signal output unit 70 in addition to a voltage output circuit control unit 30, a pulse signal output unit 40, and a voltage clamp unit 50.

The first signal output unit 70 includes an RS flip-flop 71, a comparator 72, a DC power supply 73, a mask circuit 74, a NAND gate circuit 75, a comparator 76, and a DC power supply 77.

The comparator 76 corresponds to a first comparator of the present disclosure. The comparator 72 corresponds to a second comparator of the present disclosure.

The flip-flop 71 is set in a case where an output signal of the NAND gate circuit 75 is at a low level, and outputs a high-level detection control signal S₁.

The flip-flop 71 is reset in a case where an output signal of the comparator 72 is at a low level, and outputs a low-level detection control signal S₁.

The NAND gate circuit 75 outputs a low-level signal to an inverting set terminal of the flip-flop 71 in a case where an output signal of the comparator 76 is at a high level and an output signal of the mask circuit 74 is at a high level. The NAND gate circuit 75 outputs a high-level signal to the inverting set terminal of the flip-flop 71 in other cases.

A clamp voltage S₈ is input into an inverting input terminal of the comparator 76. As described earlier, the clamp voltage S₈ changes from 0 V to 5 V.

A voltage of the DC power supply 77 is input into a non-inverting input terminal of the comparator 76. The DC power supply 77 outputs a first threshold voltage. The first threshold voltage may be 5 V, which is a predetermined voltage, but is preferably a voltage lower than 5 V in order to secure a stable operation margin. For example, the first threshold voltage is exemplified by about 4.7 V, but the present disclosure is not limited thereto. When the first threshold voltage is set to the voltage lower than 5 V, the comparator 76 can securely detect that the clamp voltage S₈ is decreased to 5 V or lower.

The comparator 76 outputs a high-level signal to one input terminal of the NAND gate circuit 75 in a case where the clamp voltage S₈ is equal to or lower than the first threshold voltage (such as 4.7 V). The comparator 76 outputs a low-level signal to the one input terminal of the NAND gate circuit 75 in a case where the clamp voltage S₈ is higher than the first threshold voltage.

The mask circuit 74 outputs an inversion output signal of the flip-flop 71 (inversion signal of the detection control signal S₁) to the other input terminal of the NAND gate circuit 75. However, in a predetermined period after the inversion output signal of the flip-flop 71 changes from a high level to a low level, the mask circuit 74 keeps an output of the NAND gate circuit 75 at a high level and does not output a low level even when the comparator 76 outputs a high level. That is, the mask circuit 74 masks an output signal of the comparator 76. Thus, the mask circuit 74 can control chattering.

An output control signal S₂ is input into the inverting input terminal of the comparator 72. As described earlier, the output control signal S₂ changes in a sinusoidal manner in a range of 0 V to 1 V.

A voltage of the DC power supply 73 is input into a non-inverting input terminal of the comparator 72. The DC power supply 73 outputs a second threshold voltage. The second threshold voltage is exemplified by 12 mV (=5 V/410), but the present disclosure is not limited thereto. Note that in a case where the output control signal S₂ is 12 mV, the control circuit 8C controls a voltage output circuit 7 in such a manner as to apply, to an electrostatic transducer 5, 5 V (=12 mV×410) that is a predetermined voltage.

In a case where the output control signal S₂ is equal to or lower than the second threshold voltage (such as 12 mV), the comparator 72 outputs a high-level signal to an inverting reset terminal of the flip-flop 71. In a case where the output control signal S₂ is higher than the second threshold voltage, the comparator 72 outputs a low-level signal to the inverting reset terminal of the flip-flop 71.

In summary, when the output control signal S₂ becomes higher than the second threshold voltage (such as 12 mV), the flip-flop 71 is reset, and the first signal output unit 70 outputs a low-level detection control signal S₁. Thus, the voltage output circuit control unit 30 controls the voltage output circuit 7 in such a manner as to apply a voltage corresponding to the output control signal S₂ to the electrostatic transducer 5. That is, the control circuit 8C starts causing an output of vibration, sound, or pressure.

While the output control signal S₂ is higher than the second threshold voltage (such as 12 mV), the first signal output unit 70 keeps outputting the low-level detection control signal S₁. As a result, the voltage output circuit control unit 30 keeps controlling the voltage output circuit 7 in such a manner as to apply the voltage corresponding to the output control signal S₂ to the electrostatic transducer 5.

Subsequently, when the output control signal S₂ becomes equal to or lower than the second threshold voltage (such as 12 mV) and the clamp voltage S₈ (voltage S₇) is decreased to the first threshold voltage (such as 4.7 V), the flip-flop 71 is set. Thus, the first signal output unit 70 outputs a high-level detection control signal S₁. As a result, the voltage output circuit control unit 30 stops the voltage output circuit 7. That is, the control circuit 8C starts causing detection of vibration, sound, or pressure.

Note that a microcomputer 3C does not include a detection control signal output circuit 121 as compared with the microcomputer 3 (see FIG. 1).

With the above configuration, the control circuit 8C can output a high-level detection control signal S₁ in a period in which the voltage S₇ of the electrostatic transducer 5 is equal to or lower than 5 V (period of a valley bottom of the sinusoidal voltage S₇). Thus, the control circuit 8C can make it possible to suitably detect vibration, sound, or pressure in a period in which the voltage S₇ of the electrostatic transducer 5 is equal to or lower than 5 V.

Also, the control circuit 8C can eliminate a need for the microcomputer 3C to include the detection control signal output circuit 121. Also, with the control circuit 8C, it is possible to reduce a signal line with respect to the microcomputer 3C.

Note that in a case of detecting vibration, sound, or pressure without generating vibration, sound, or pressure, the microcomputer 3C keeps the output control signal S₂ at the second threshold voltage (such as 12 mV) or lower (such as 0 V). This is because the flip-flop 71 is kept in a set state accordingly and the first signal output unit 70 keeps the detection control signal S₁ at a high level.

Note that the fourth embodiment may be combined with the second embodiment. That is, the control circuit 8C may include a voltage clamp unit 50A (see FIG. 4) instead of the voltage clamp unit 50.

Also, the fourth embodiment may be combined with the third embodiment. That is, the control circuit 8C may include a pulse signal output unit 40B (see FIG. 5) instead of the pulse signal output unit 40.

### Fifth Embodiment

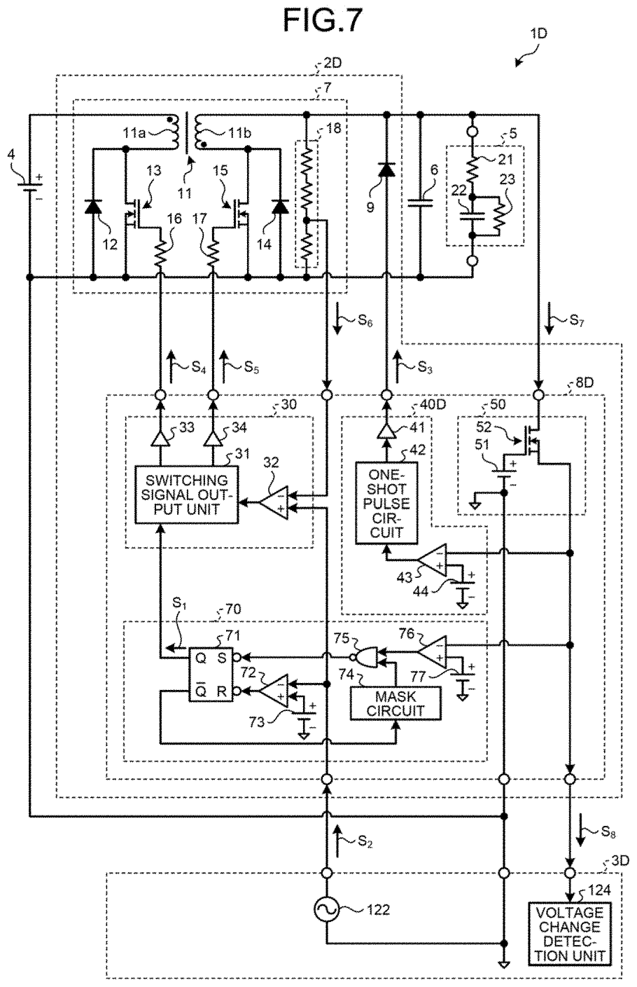

FIG. 7 is a view illustrating a configuration of a system using a control device of the fifth embodiment. Note that the same reference signs are assigned to components similar to those of the first to fourth embodiments, and a description thereof will be omitted.

A system 1D includes a control device 2D. The control device 2D includes a control circuit 8D. The control circuit 8D includes a pulse signal output unit 40D instead of a pulse signal output unit 40B as compared with the control circuit 8B (see FIG. 5).

The pulse signal output unit 40D further includes a comparator 43 and a DC power supply 44 in addition to a buffer 41 and a one-shot pulse circuit 42.

A clamp voltage S₈ is input into an inverting input terminal of the comparator 43. As described earlier, the clamp voltage S₈ changes from 0 V to 5 V.

A voltage of the DC power supply 44 is input into a non-inverting input terminal of the comparator 43. The DC power supply 44 outputs a third threshold voltage V₁. The third threshold voltage V₁ is exemplified by a voltage on which a change (decrease) of a clamp voltage S₈ substantially converges in a case where vibration, sound, or pressure is applied to an electrostatic transducer 5 (case where a time constant of the electrostatic transducer 5 is long), but the present disclosure is not limited thereto. For example, the third threshold voltage V₁ can be 1 V.

The comparator 43 outputs a high-level signal to the one-shot pulse circuit 42 in a case where the clamp voltage S₈ is equal to or lower than the third threshold voltage V₁ (such as 1 V). The comparator 43 outputs a low-level signal to the one-shot pulse circuit 42 in a case where the clamp voltage S₈ is higher than the third threshold voltage V₁.

In summary, in a case where the clamp voltage S₈ is equal to or lower than the third threshold voltage V₁ (such as 1 V), the pulse signal output unit 40D outputs a pulse signal S₃ having a predetermined time width to an electrostatic transducer 5 via a diode 9.

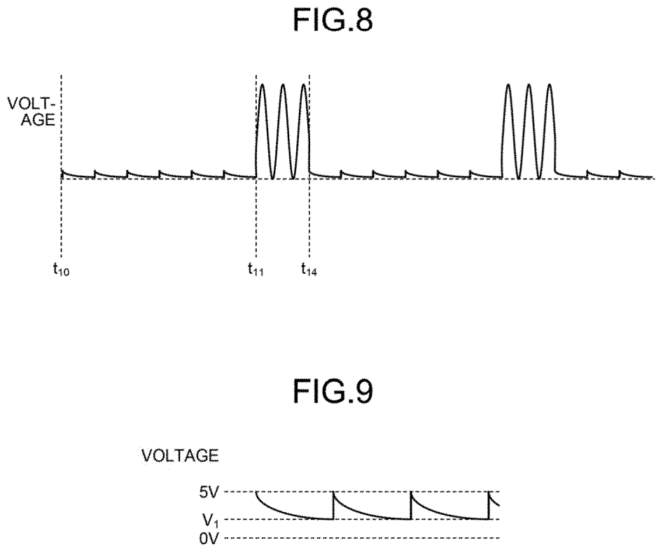

FIG. 8 to FIG. 10 are views illustrating a voltage waveform of the electrostatic transducer of the fifth embodiment.

Referring to FIG. 8, timing t₁₀ to timing t₁₁ is a period in which the electrostatic transducer 5 detects vibration, sound, or pressure (see FIG. 9 described later).

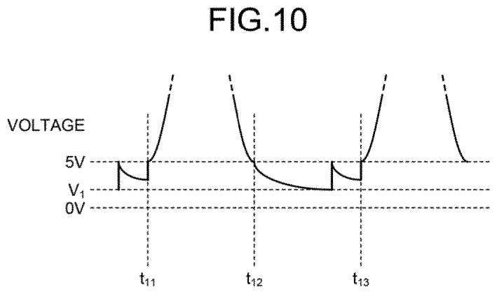

The timing t₁₁ to timing t₁₄ is a period in which the electrostatic transducer 5 outputs vibration, sound, or pressure. However, at the timing t₁₁ to the timing t₁₄, a period in which the voltage S₇ of the electrostatic transducer 5 is equal to or lower than 5 V (period of a valley bottom of the sinusoidal voltage S₇) is a period in which the electrostatic transducer 5 detects vibration, sound, or pressure (See FIG. 10 described later).

FIG. 9 is a partially enlarged view of the period from the timing t₁₀ to timing t₁₁ in FIG. 8.

When the pulse signal output unit 40D outputs a pulse signal S₃ of 5 V to the electrostatic transducer 5, a voltage of the electrostatic transducer 5 becomes 5 V. Subsequently, when the voltage of the electrostatic transducer 5 reaches the third threshold voltage V₁, the pulse signal output unit 40D outputs the pulse signal S₃ of 5 V again to the electrostatic transducer 5. The pulse signal output unit 40D repeats the above operation.

FIG. 10 is a partially enlarged view of the period from the timing t₁₁ to timing t₁₄ in FIG. 8. At the timing t₁₁, an output control signal output circuit 122 in a microcomputer 3D outputs an output control signal S₂ higher than 12 mV to the control circuit 8D. A first signal output unit 70 outputs a low-level detection control signal S₁ to a voltage output circuit control unit 30. The voltage output circuit control unit 30 controls a voltage output circuit 7 in such a manner as to output a voltage that changes in a sinusoidal manner up to 410 V.

At the timing t₁₂, the output control signal output circuit 122 in the microcomputer 3D outputs an output control signal S₂ equal to or lower than 12 mV to the control circuit 8D. When the voltage S₇ of the electrostatic transducer 5 is decreased to 5 V (specifically, 4.7 V), the first signal output unit 70 outputs a high-level detection control signal S₁ to the voltage output circuit control unit 30. The voltage output circuit control unit 30 stops the voltage output circuit 7. When the clamp voltage S₈ is decreased to the third threshold voltage V₁ (such as 1 V) or lower, the pulse signal output unit 40D outputs a pulse signal S₃ of 5 V to the electrostatic transducer 5. Then, the voltage of the electrostatic transducer 5 becomes 5 V. Subsequently, when the voltage S₇ of the electrostatic transducer 5 reaches the third threshold voltage V₁ again, the pulse signal output unit 40D outputs the pulse signal S₃ of 5 V again to the electrostatic transducer 5. The pulse signal output unit 40D repeats the above operation.

At the timing t₁₃, the output control signal output circuit 122 in the microcomputer 3D outputs an output control signal S₂ higher than 12 mV to the control circuit 8D. The first signal output unit 70 outputs a low-level detection control signal S₁ to the voltage output circuit control unit 30. The voltage output circuit control unit 30 controls the voltage output circuit 7 in such a manner as to output a voltage that changes in a sinusoidal manner up to 410 V.

Note that the microcomputer 3D does not include a pulse signal generation circuit 123 as compared with the microcomputer 3C (see FIG. 6).

With the above configuration, the control circuit 8D can output a pulse signal S₃ in a period in which the voltage S₇ (clamp voltage S₈) of the electrostatic transducer 5 is equal to or lower than 5 V (period of a valley bottom of the sinusoidal voltage S₇). Thus, the control circuit 8D can eliminate a need for the microcomputer 3D to include the pulse signal generation circuit 123. Also, with the control circuit 8D, it is possible to reduce a signal line with respect to the microcomputer 3D.

Note that the fifth embodiment may be combined with the second embodiment. That is, the control circuit 8D may include a voltage clamp unit 50A (see FIG. 4) instead of a voltage clamp unit 50.

### Sixth Embodiment

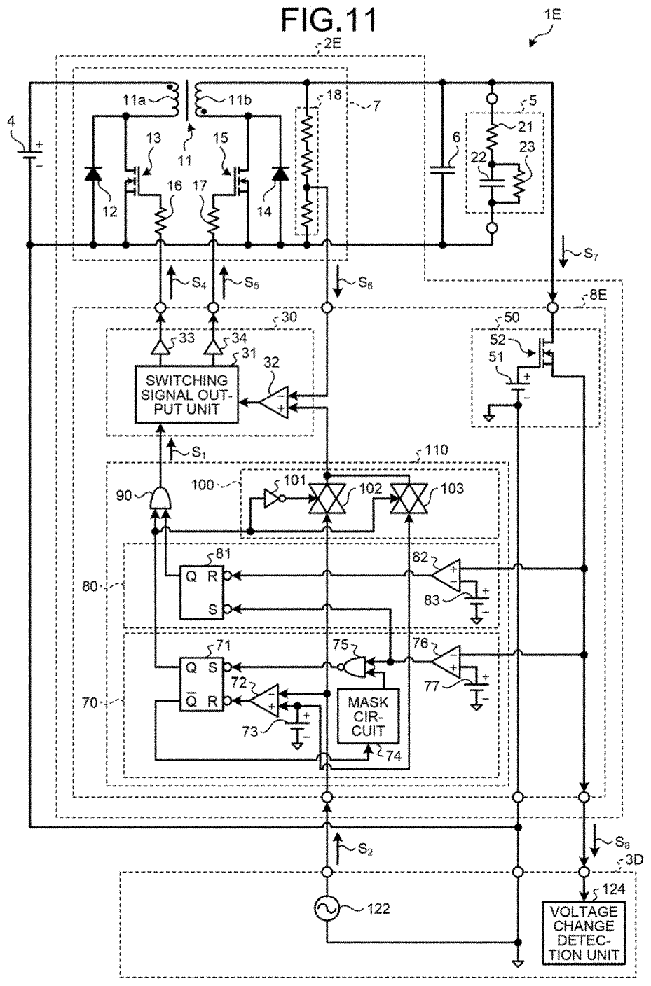

FIG. 11 is a view illustrating a configuration of a system using a control device of the sixth embodiment. Note that the same reference signs are assigned to components similar to those of the first to fifth embodiments, and a description thereof will be omitted.

A system 1E includes a control device 2E. The control device 2E includes a control circuit 8E. The control circuit 8E includes a signal output unit 110 in addition to a voltage output circuit control unit 30 and a voltage clamp unit 50 as compared with the control circuit 8 (see FIG. 1). Also, the control circuit 8E does not include a pulse signal output unit 40.

The signal output unit 110 includes a first signal output unit 70, a second signal output unit 80, a third signal output unit 90, and a fourth signal output unit 100.

The second signal output unit 80 includes an RS flip-flop 81, a comparator 82, and a DC power supply 83.

The flip-flop 81 is set in a case where an output signal of a comparator 76 is at a low level, and outputs a high-level signal.

The flip-flop 81 is reset in a case where an output signal of the comparator 82 is at a low level, and outputs a low-level signal.

A clamp voltage S₈ is input into a non-inverting input terminal of the comparator 82. As described earlier, the clamp voltage S₈ changes from 0 V to 5 V.

A voltage of the DC power supply 83 is input into an inverting input terminal of the comparator 82. The DC power supply 83 outputs a third threshold voltage V₁. The third threshold voltage V₁ is exemplified by a voltage on which a change (decrease) of the clamp voltage S₈ substantially converges in a case where vibration, sound, or pressure is applied to an electrostatic transducer 5 (case where a time constant of the electrostatic transducer 5 is long), but the present disclosure is not limited thereto. For example, the third threshold voltage V₁ can be 1 V.

In a case where the clamp voltage S₈ is equal to or higher than the third threshold voltage V₁, the comparator 82 outputs a high-level signal to an inverting reset terminal of the flip-flop 81. In a case where the clamp voltage S₈ is lower than the third threshold voltage V₁, the comparator 82 outputs a low-level signal to the inverting reset terminal of the flip-flop 81.

In summary, the flip-flop 81 is set and outputs a high-level signal in a case where the clamp voltage S₈ is higher than 5 V (specifically, 4.7 V). Also, the flip-flop 81 is reset and outputs a low-level signal in a case where the clamp voltage S₈ is lower than the third threshold voltage V₁. Here, the clamp voltage S₈ fluctuates in a range of 0 V to 5 V. Thus, the second signal output unit 80 outputs a high-level signal when the clamp voltage S₈ is increased above 5 V (specifically, 4.7 V), and outputs a low-level signal when the clamp voltage S₈ is decreased below 1 V.

The third signal output unit 90 is an AND gate circuit. The third signal output unit 90 outputs a high-level detection control signal S₁ in a case where an output signal of the flip-flop 71 is at a high level and the output signal of the flip-flop 81 is at a high level. The third signal output unit 90 outputs a low-level detection control signal S₁ in other cases.

The fourth signal output unit 100 includes an inverter (inverting circuit) 101, and switches 102 and 103. The switches 102 and 103 are exemplified by transfer gates, but the present disclosure is not limited thereto.

The inverter 101 inverts the output signal of the flip-flop 71, and performs an output thereof to a control input terminal of the switch 102. The output signal of the flip-flop 71 is input into a control input terminal of the switch 103.

The fourth signal output unit 100 outputs an output control signal S₂ to a non-inverting input terminal of an error amplifier 32 in a case where the output signal of the flip-flop 71 is at a low level. In a case where the output signal of the flip-flop 71 is at a high level, the fourth signal output unit 100 outputs a second threshold voltage (such as 12 mV) of a DC power supply 73 to the non-inverting input terminal of the error amplifier 32.

In summary, when the output control signal S₂ becomes higher than the second threshold voltage (such as 12 mV), the flip-flop 71 is reset, and the third signal output unit 90 outputs a low-level detection control signal S₁. Here, the output control signal S₂ is input into the non-inverting input terminal of the error amplifier 32. Thus, the voltage output circuit control unit 30 controls the voltage output circuit 7 in such a manner as to apply a voltage corresponding to the output control signal S₂ to the electrostatic transducer 5. That is, the control circuit 8E starts causing an output of vibration, sound, or pressure. Then, when the clamp voltage S₈ is increased above 5 V (specifically, 4.7 V), the flip-flop 81 is set.

While the output control signal S₂ is higher than the second threshold voltage (such as 12 mV), the third signal output unit 90 keeps outputting the low-level detection control signal S₁. As a result, the voltage output circuit control unit 30 keeps controlling the voltage output circuit 7 in such a manner as to apply the voltage corresponding to the output control signal S₂ to the electrostatic transducer 5.

Subsequently, when the output control signal S₂ becomes equal to or lower than the second threshold voltage (such as 12 mV) and the clamp voltage S₈ is decreased to 5 V (specifically, 4.7 V) or lower, the flip-flop 71 is set, and the third signal output unit 90 outputs a high-level detection control signal S₁. Thus, the voltage output circuit control unit 30 stops the voltage output circuit 7. That is, the control circuit 8E starts causing detection of vibration, sound, or pressure.

Subsequently, when the clamp voltage S₈ is decreased below a third threshold voltage V₁ (such as 1 V), the flip-flop 81 is reset, and the third signal output unit 90 outputs the low-level detection control signal S₁. Here, the second threshold voltage (such as 12 mV) is input into the non-inverting input terminal of the error amplifier 32. Thus, the voltage output circuit control unit 30 controls the voltage output circuit 7 in such a manner as to apply 5 V to the electrostatic transducer 5. That is, the control circuit 8E controls the voltage output circuit 7 in such a manner as to apply, to the electrostatic transducer 5, a pulse signal of 5 V which signal is to cause detection of vibration, sound, or pressure.

Then, when the clamp voltage S₈ is increased above 5 V (specifically, 4.7 V), the flip-flop 81 is set, and the third signal output unit 90 outputs the high-level detection control signal S₁. Thus, the voltage output circuit control unit 30 stops the voltage output circuit 7. That is, the control circuit 8E starts causing detection of vibration, sound, or pressure.

Subsequently, when the clamp voltage S₈ is decreased below the third threshold voltage V₁ (such as 1 V), the flip-flop 81 is reset, and the third signal output unit 90 outputs the low-level detection control signal S₁. Here, the second threshold voltage (such as 12 mV) is input into the non-inverting input terminal of the error amplifier 32. Thus, the voltage output circuit control unit 30 controls the voltage output circuit 7 in such a manner as to apply 5 V to the electrostatic transducer 5. That is, the control circuit 8E controls the voltage output circuit 7 in such a manner as to apply, to the electrostatic transducer 5, a pulse signal of 5 V which signal is to cause detection of vibration, sound, or pressure.

With the above configuration, in a period in which the voltage S₇ (clamp voltage S₈) of the electrostatic transducer 5 is equal to or lower than 5 V (period of a valley bottom of the sinusoidal voltage S₇), the control circuit 8E can control the voltage output circuit 7 in such a manner as to apply, to the electrostatic transducer 5, a pulse signal for causing detection of vibration, sound, or pressure. Thus, the control circuit 8E can eliminate a need for a pulse signal output unit 40 and a diode 9.

Note that in a case of detecting vibration, sound, or pressure without generating vibration, sound, or pressure, the microcomputer 3D keeps the output control signal S₂ at the second threshold voltage (such as 12 mV) or lower (such as 0 V). This is because the clamp voltage S₈ is decreased to the first threshold voltage and the flip-flop 71 is set accordingly and the flip-flop 71 keeps a high level while the output control signal S₂ is equal to or lower than the second threshold voltage.

Note that the sixth embodiment may be combined with the second embodiment. That is, the control circuit 8E may include a voltage clamp unit 50A (see FIG. 4) instead of the voltage clamp unit 50.

Although some embodiments of the present invention have been described, these embodiments are presented as examples and are not intended to limit the scope of the invention. These embodiments can be implemented in various other forms, and various kinds of omission, replacement, and modifications can be made without departing from the spirit of the invention. These embodiments and modifications thereof are included in the scope of the invention described in claims and the equivalent thereof, as well as in the spirit and scope of the invention.

### REFERENCE SIGNS LIST

1, 1A, 1B, 1C, 1D, 1E SYSTEM
2, 2A, 2B, 2C, 2D, 2E CONTROL DEVICE
3, 3A, 3C, 3D MICROCOMPUTER
4, 44, 51, 73, 77, 83 DC POWER SUPPLY
5 ELECTROSTATIC TRANSDUCER
6 CAPACITOR
7 VOLTAGE OUTPUT CIRCUIT
8, 8A, 8B, 8C, 8D, 8E CONTROL CIRCUIT
9 DIODE
30 VOLTAGE OUTPUT CIRCUIT CONTROL UNIT
31 SWITCHING SIGNAL OUTPUT UNIT
32 ERROR AMPLIFIER
33, 34, 41 BUFFER
40, 40B, 40D PULSE SIGNAL OUTPUT UNIT
42 ONE-SHOT PULSE CIRCUIT
43, 72, 76, 82 COMPARATOR
50, 50A VOLTAGE CLAMP UNIT
52, 62, 63 TRANSISTOR
60 BIAS CUT-OFF UNIT
61, 101 INVERTER
70 FIRST SIGNAL OUTPUT UNIT
71, 81 FLIP-FLOP
74 MASK CIRCUIT
75 NAND GATE CIRCUIT
80 SECOND SIGNAL OUTPUT UNIT
90 THIRD SIGNAL OUTPUT UNIT
100 FOURTH SIGNAL OUTPUT UNIT
102, 103 SWITCH
110 SIGNAL OUTPUT UNIT
121 DETECTION CONTROL SIGNAL OUTPUT CIRCUIT
122 OUTPUT CONTROL SIGNAL OUTPUT CIRCUIT
123 PULSE SIGNAL GENERATION CIRCUIT
124 VOLTAGE CHANGE DETECTION UNIT

1. A control circuit that controls an electrostatic transducer capable of generating vibration, sound, or pressure and detecting vibration, sound, or pressure, the control circuit comprising:
a voltage output circuit control unit that controls a voltage output circuit in such a manner as to apply a voltage, which corresponds to an output control signal and is to cause the electrostatic transducer to generate vibration, sound, or pressure, between both ends of the electrostatic transducer in a case where a detection control signal is at a first level, and that stops the voltage output circuit in a case where the detection control signal is at a second level;
a pulse signal output unit that outputs a pulse signal, which is to cause the electrostatic transducer to detect vibration, sound, or pressure, to a terminal on a high potential side of the electrostatic transducer via a diode; and
a voltage clamp unit that outputs a clamp voltage acquired by clamping of a voltage between the terminals of the electrostatic transducer to a predetermined voltage or lower.

2. The control circuit according to claim 1, wherein
the pulse signal output unit
generates the pulse signal when the detection control signal changes from the first level to the second level.

3. The control circuit according to claim 1, further comprising
a first signal output unit that outputs the detection control signal at the second level in a case where the output control signal indicates that a voltage equal to or lower than the predetermined voltage is output between the both ends of the electrostatic transducer and a case where the clamp voltage is equal to or lower than the predetermined voltage, and outputs the detection control signal at the first level in a case where the output control signal indicates that a voltage higher than the predetermined voltage is output between the both ends of the electrostatic transducer or a case where the clamp voltage is higher than the predetermined voltage.

4. The control circuit according to claim 3, wherein
the first signal output unit includes
a first comparator that compares the clamp voltage with a first threshold voltage,
a second comparator that compares the output control signal with a second threshold voltage, and
a flip-flop that is set by an output signal of the first comparator, is reset by an output signal of the second comparator, and outputs the detection control signal.

5. The control circuit according to claim 4, wherein
the first signal output unit further includes
a mask circuit that masks the output signal of the first comparator in a predetermined period after the detection control signal changes.

6. The control circuit according to claim 3, wherein
the pulse signal output unit
generates the pulse signal in a case where the clamp voltage is equal to or lower than a third threshold voltage.

7. A control circuit that controls an electrostatic transducer capable of generating vibration, sound, or pressure and detecting vibration, sound, or pressure, the control circuit comprising:
a voltage output circuit control unit that controls a voltage output circuit in such a manner as to apply a voltage, which corresponds to an input signal, between both ends of the electrostatic transducer in a case where a detection control signal is at a first level, and that stops the voltage output circuit in a case where the detection control signal is at a second level;
a voltage clamp unit that outputs a clamp voltage acquired by clamping of a voltage between the terminals of the electrostatic transducer to a predetermined voltage or lower;
a first signal output unit that outputs a signal at the second level in a case where an output control signal indicates that a voltage equal to or lower than the predetermined voltage is output between the both ends of the electrostatic transducer and a case where the clamp voltage is equal to or lower than the predetermined voltage, and outputs a signal at the first level in a case where the output control signal indicates that a voltage higher than the predetermined voltage is output between the both ends of the electrostatic transducer or a case where the clamp voltage is higher than the predetermined voltage;
a second signal output unit that outputs the signal at the second level when the clamp voltage is increased above the predetermined voltage, and outputs the signal at the first level when the clamp voltage is decreased below a third threshold voltage;
a third signal output unit that outputs the detection control signal at the second level in a case where a signal output by the first signal output unit is at the second level and a signal output by the second signal output unit is at the second level, and outputs the detection control signal at the first level in a case where the signal output by the first signal output unit is at the first level or the signal output by the second signal output unit is at the first level; and
a fourth signal output unit that outputs the output control signal as the input signal to the voltage output circuit control unit in a case where the signal output by the first signal output unit is at the first level, and outputs a second threshold voltage as the input signal to the voltage output circuit control unit in a case where the signal output by the first signal output unit is at the second level.

8. The control circuit according to claim 1, wherein
the voltage clamp unit includes
a transistor a drain of which is connected to the terminal on the high potential side of the electrostatic transducer, to a gate of which a bias voltage is supplied, and from a source of which the clamp voltage is output, and
a bias cut-off unit that cuts off supply of the bias voltage to the gate in a case where the detection control signal is at the first level.

9. The control circuit according to claim 1, wherein
the electrostatic transducer is an electrostatic actuator or an electrostatic pressure detecting element.

10. The control circuit according to claim 1, wherein
the control circuit is a semiconductor integrated circuit.

11. A control device comprising:
the control circuit according to claim 1; and
the voltage output circuit.

12. A system comprising:
the control device according to claim 11; and
a voltage change detection unit that detects vibration, sound, or pressure applied to the electrostatic transducer on the basis of a change in the clamp voltage.
